(19) United States
(12) Patent Application Publication
(10) Pub. No.: US 2023/0089106 A1
(43) Pub. Date: Mar. 23, 2023

(54) SYSTEMS AND METHODS FOR OPERATING DURING A TRANSITION PHASE WHEN A WIRELESS DEVICE TRANSITIONS BETWEEN OPERATIONAL SCENARIOS

(71) Applicant: Telefonaktiebolaget LM Ericsson (publ), Stockholm (SE)

(72) Inventors: Santhan Thangarasa, Vällingby (SE); Muhammad Ali Kazmi, Sundbyberg (SE)

(21) Appl. No.: 17/798,621

(22) PCT Filed: Feb. 11, 2021
(86) PCT No.: PCT/IB2021/051130

§ 371 Date: Aug. 10, 2022

Related U.S. Application Data
(60) Provisional application No. 62/972,954, filed on Feb. 11, 2020.

(51) Int. Cl. H04W 24/10

(52) U.S. Cl. CPC H04W 24/10

(57) ABSTRACT

Systems and methods are disclosed herein that relate to operation of a wireless device during a transition period between operational scenarios. In one embodiment, a method performed by a wireless device comprises determining that a transition of the wireless device from a first operational scenario to a second operational scenario has occurred and determining one or more measurement requirements that are applicable during a transition period based on the determined transition, wherein the transition period starts at a moment that the wireless device determines that the transition from the first operational scenario to the second operational scenario has occurred and ends at a time at which the wireless device is to apply a set of measurement requirements associated to the second operational scenario. The method further comprises adapting one or more measurement procedures to fulfill the one or more measurement requirements during the transition period. In this manner, more robust performance is achieved.

### RELATED APPLICATIONS

This application claims the benefit of provisional patent application Ser. No. 62/972,954, filed Feb. 11, 2020, the disclosure of which is hereby incorporated herein by reference in its entirety.

### TECHNICAL FIELD

The present disclosure relates to measurements performed in a wireless network and, more specifically, measurement requirements when a wireless device transitions between two different operational states.

### BACKGROUND

Radio measurements done by a User Equipment (UE) in a Third Generation Partnership Project (3GPP) cellular network are typically performed on the serving cell as well as on neighbor cells over some known reference symbols or pilot sequences. The measurements are done on cells on an intra-frequency carrier, cells on an inter-frequency carrier(s), and cells on inter-Radio Access Technology (RAT) carriers(s) depending upon the UE capability to support that RAT. To enable inter-frequency and inter-RAT measurements for the UE requiring measurement gaps, the network has to configure the measurement gaps.

The measurements are done for various purposes. Some example measurement purposes are: mobility, positioning, Self-Organizing Network (SON), Minimization of Drive Tests (MDT), Operation and Maintenance (O&M), network planning and optimization, etc. Examples of measurements in Long Term Evolution (LTE) are cell identification (i.e., Physical Cell Identity (PCI) acquisition), Reference Symbol Received Power (RSRP), Reference Symbol Received Quality (RSRQ), Narrowband RSRP (NRSRP), Narrowband RSRQ (NRSRQ), Sidelink RSRP (S-RSRP), Reference Signal (RS) SINR (RS-SINR), Channel State Information (CSI) RSRP (CSI-RSRP), acquisition of System Information (SI), Cell Global ID (CGI) acquisition, Reference Signal Time Difference (RSTD), UE Receive (RX)—Transmit (TX) time difference measurement, Radio Link Monitoring (RLM), which consists of Out of Synchronization (out of sync) detection and In Synchronization (in-sync) detection, etc. CSI measurements performed by the UE are used by the network for scheduling, link adaptation, etc. Examples of CSI measurements or CSI reports are Channel Quality Indictor (CQI), Precoding Matrix Indicator (PMI), Rank Indicator (RI), etc. They may be performed on reference signals such as Cell-specific Reference Signal (CRS), CSI-RS, or Demodulation Reference Signal (DMRS).

The DL subframe #0 and subframe #5 carry synchronization signals (i.e., both Primary Synchronization Signal (PSS) and Secondary Synchronization Signal (SSS)). In order to identify an unknown cell (e.g., new neighbor cell), the UE has to acquire the timing of that cell and eventually the Physical Cell ID (PCI). This is called “cell search” or “cell identification” or even “cell detection.” Subsequently, the UE also measures RSRP and/or RSRQ of the newly identified cell in order to use the measurement itself and/or report the measurement to the network node. In total, there are 504 PCIs. The cell search is also a type of measurement.

The measurements may be unidirectional (e.g., downlink (DL) or uplink (UL)) or bidirectional (e.g., having UL and DL components such as Rx-Tx, Round Trip Time (RTT), etc.). The measurements are done in all Radio Resource Control (RRC) states, i.e. in RRC idle and RRC connected states.

The relaxed monitoring criteria for a neighbor cell are specified in Third Generation Partnership Project (3GPP) Technical Specification (TS) 36.304 (see, e.g., v15.2.0). When the UE is required to perform intra-frequency or inter-frequency measurement, the UE may choose not to perform intra-frequency or inter-frequency measurements when:
the relaxed monitoring criterion is fulfilled for a period of T_{SearchDeltaP}, and
less than 24 hours have passed since measurements for cell reselection were last performed, and
the UE has performed intra-frequency or inter-frequency measurements for at least T_{SearchDeltaP} after selecting or reselecting a new cell.

The relaxed monitoring criterion is fulfilled when:

(Srxlev_{Ref}−Srxlev)<S_{SearchDeltaP}

where:
Srxlev=current Srxlev value of the serving cell (dB), and
Srxlev_{Ref}=reference Srxlev value of the serving cell (dB), set as follows:
   after selecting or reselecting a new cell, or
   if (Srxlev−Srxlev_{Ref})>0, or
   if the relaxed monitoring criterion has not been met for T_{SearchDeltaP}:
      the UE shall set the value of Srxlev_{Ref} to the current Srxlev value of the serving cell;
   T_{SearchDeltaP}=5 minutes, or the enhanced Discontinuous Reception (eDRX) cycle length if eDRX is configured and the eDRX cycle length is longer than 5 minutes.

### SUMMARY

Systems and methods are disclosed herein that relate to operation of a wireless device during a transition period between operational scenarios. In one embodiment, a method performed by a wireless device comprises determining that a transition of the wireless device from a first operational scenario to a second operational scenario has occurred and determining one or more measurement requirements that are applicable during a transition period based on the determined transition, wherein the transition period starts at a moment that the wireless device determines that the transition from the first operational scenario to the second operational scenario has occurred and ends at a time at which the wireless device is to apply a set of measurement requirements associated to the second operational scenario. The method further comprises adapting one or more measurement procedures to fulfill the one or more measurement requirements during the transition period. In this manner, more robust performance is achieved.

In one embodiment, the first operational scenario is associated with one or more first requirements, the second operational scenario is associated with one or more second requirements, and determining the one or more requirements that are applicable during the transition period comprises selecting either the one or more first requirements or the one or more second requirements based on whether the one or more first requirements are more or less stringent than the one or more second requirements.

In one embodiment, the first operational scenario and the second operational scenario are comprised in a set of two or more operational scenarios, one or more requirements are predefined or preconfigured for each possible transition between operational scenarios in the set of two or more operational scenarios, and determining the one or more requirements that are applicable during the transition period comprises selecting the one or more predefined or preconfigured requirements for the determined transition, the determined transition being one of the possible transitions between operational scenarios in the set of two or more operational scenarios.

In one embodiment, the first operational scenario is associated with one or more first requirements, the second operational scenario is associated with one or more second requirements, and determining the one or more requirements that are applicable during the transition period comprises selecting the one or more first requirements regardless of whether the one or more first requirements are more or less stringent than the one or more second requirements.

In one embodiment, the first operational scenario is one of a set of two or more operational scenarios, the second operational scenario is a different one of the set of two or more operational scenarios. In one embodiment, the set of two or more operational scenarios comprises a low mobility scenario and a non-cell-edge scenario.

In another embodiment, the set of two or more operational scenarios comprises a low mobility scenario, a non-cell-edge scenario, and a low mobility and non-cell-edge scenario.

In one embodiment, a first set of measurement requirements associated to the first operational scenario is more stringent than a second set of measurement requirements associated to the second operational scenario, and the transition period is an amount of time that is greater than zero.

In one embodiment, a first set of measurement requirements associated to the first operational scenario is less stringent than a second set of measurement requirements associated to the second operational scenario, and the transition period is an amount of time that is equal to zero.

In one embodiment, a first set of measurement requirements associated to the first operational scenario is less stringent than a second set of measurement requirements associated to the second operational scenario, and the transition period is an amount of time that is greater than zero.

In one embodiment, the one or more measurement requirements to apply during the transition period and the one or more measurement procedures are associated to measurements performed on a serving carrier of the wireless device and measurements performed on one or more non-serving carriers.

In one embodiment, the one or more measurement requirements to apply during the transition period comprise: (a) a measurement time, (b) a measurement rate, (c) a measurement accuracy, (d) a number of cells to measure over a measurement time, (e) a number of carriers to monitor, (f) a signal level down to which the one or more measurement requirements are to be met, or (g) a combination of any two or more of (a)—(f).

In one embodiment, the one or more measurement requirements to apply during the transition period for the determined transition from the first operational scenario to the second operational scenario are predefined, received via a broadcast from a network node, or received via dedicated signaling from a network node.

Corresponding embodiments of a wireless device are also disclosed. In one embodiment, a wireless device is adapted to determine that a transition of the wireless device from a first operational scenario to a second operational scenario has occurred and determine one or more measurement requirements that are applicable during a transition period based on the determined transition, wherein the transition period starts at a moment that the wireless device determines that the transition from the first operational scenario to the second operational scenario has occurred and ends at a time at which the wireless device is to apply a set of measurement requirements associated to the second operational scenario. The wireless device is further adapted to adapt one or more measurement procedures to fulfill the one or more measurement requirements during the transition period.

In one embodiment, a wireless device comprises one or more transmitters, one or more receivers, and processing circuitry associated with the one or more transmitters and the one or more receivers. The processing circuitry is configured to cause the wireless device to determine that a transition of the wireless device from a first operational scenario to a second operational scenario has occurred and determine one or more measurement requirements that are applicable during a transition period based on the determined transition, wherein the transition period starts at a moment that the wireless device determines that the transition from the first operational scenario to the second operational scenario has occurred and ends at a time at which the wireless device is to apply a set of measurement requirements associated to the second operational scenario. The processing circuitry is further configured to cause the wireless device to adapt one or more measurement procedures to fulfill the one or more measurement requirements during the transition period.

Embodiments of a computer program are disclosed wherein the computer program comprises instructions which, when executed on at least one processor, cause the at least one processor to carry out the method of operation of a wireless device according to any of the embodiments described herein. In one embodiment, a carrier containing the computer program is provided, wherein the carrier is one of an electronic signal, an optical signal, a radio signal, or a computer readable storage medium.

In one embodiment, a non-transitory computer readable medium is provided, wherein the non-transitory computer readable medium comprises instructions executable by processing circuitry of a wireless device to thereby cause the wireless device to determine that a transition of the wireless device from a first operational scenario to a second operational scenario has occurred, determine one or more measurement requirements that are applicable during a transition period based on the determined transition wherein the transition period starts at a moment that the wireless device determines that the transition from the first operational scenario to the second operational scenario has occurred and ends at a time at which the wireless device is to apply a set of measurement requirements associated to the second operational scenario, and adapt one or more measurement procedures to fulfill the one or more measurement requirements during the transition period.

Embodiments of a method performed by a network node are also disclosed. In one embodiment, a method performed by a network node comprises providing, to one or more wireless devices, information that defines, for each transition between two operational states in a set of two or more operational states, one or more measurement requirements that are applicable during a transition period and the transition period.

In one embodiment, the set of two or more operational scenarios comprises a low mobility scenario and a non-cell-edge scenario. In another embodiment, the set of two or more operational scenarios comprises a low mobility scenario, a non-cell-edge scenario, and a low mobility and non-cell-edge scenario.

In one embodiment, for each transition, the one or more requirements that are applicable during the transition period for the transition comprise either one or more first requirements associated to a source operational scenario for the transition or one or more second requirements associated to a target operational scenario for the transition depending on whether the one or more first requirements are more or less stringent than the one or more second requirements.

In one embodiment, for each transition, the one or more requirements that are applicable during the transition period for the transition comprise one or more first requirements associated to a source operational scenario for the transition regardless of whether the one or more first requirements are more or less stringent than one or more second requirements associated to a target operational scenario for the transition.

In one embodiment, for each transition for which a first set of measurement requirements associated to a source operational scenario is more stringent than a second set of measurement requirements associated to a second target operational scenario for the transition, the transition period is an amount of time that is greater than zero.

In one embodiment, for each transition for which a first set of measurement requirements associated to a source operational scenario is less stringent than a second set of measurement requirements associated to a second target operational scenario for the transition, the transition period is an amount of time that is equal to zero.

In one embodiment, for each transition for which a first set of measurement requirements associated to a source operational scenario is less stringent than a second set of measurement requirements associated to a second target operational scenario for the transition, the transition period is an amount of time that is greater than zero.

In one embodiment, for each transition, the one or more measurement requirements to apply during the transition period are associated to measurements performed on a serving carrier of the wireless device (112) and measurements performed on one or more non-serving carriers.

In one embodiment, for each transition, the one or more measurement requirements to apply during the transition period comprise: (a) a measurement time, (b) a measurement rate, (c) a measurement accuracy, (d) a number of cells to measure over a measurement time, (e) a number of carriers to monitor, (f) a signal level down to which the one or more measurement requirements are to be met, or (g) a combination of any two or more of (a)—(f).

In one embodiment, providing the information to the one or more wireless devices comprises broadcasting the information. In another embodiment, providing the information to the one or more wireless devices comprises providing the information to each of the one or more wireless device via dedicated signaling.

Corresponding embodiments of a network node are also disclosed. In one embodiment, a network node for a cellular communications system is adapted to provide, to one or more wireless devices, information that defines, for each transition between two operational states in a set of two or more operational states, one or more measurement requirements that are applicable during a transition period and the transition period.

In one embodiment, a network node for a cellular communications system comprises processing circuitry configured to cause the network node to provide, to one or more wireless devices, information that defines, for each transition between two operational states in a set of two or more operational states, one or more measurement requirements that are applicable during a transition period and the transition period.

Embodiments of a computer program are disclosed, wherein the computer program comprises instructions which, when executed on at least one processor, cause the at least one processor to carry out the method of operation of a network node according to any of the embodiments disclosed herein. In one embodiment, a carrier containing the computer program is provided, wherein the carrier is one of an electronic signal, an optical signal, a radio signal, or a computer readable storage medium.

In one embodiment, a non-transitory computer readable medium is provided, wherein the non-transitory computer readable medium comprises instructions executable by processing circuitry of a network node to thereby cause the network node to provide, to one or more wireless devices, information that defines, for each transition between two operational states in a set of two or more operational states, one or more measurement requirements that are applicable during a transition period and the transition period.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system in which embodiments of the present disclosure may be implemented;

FIG. 2 is a flow chart that illustrates the operation of a User Equipment (UE) in accordance with one embodiment of the present disclosure;

FIGS. 3 through 6 illustrate examples of transitions between operational scenarios;

FIGS. 7 through 9 illustrate further examples of transitions between operational scenarios including a transition period in accordance with embodiments of the present disclosure;

FIG. 10 illustrates an advantage of one example embodiment of the present disclosure;

FIGS. 11 through 13 are schematic block diagrams of example embodiments of a radio access node;

FIGS. 14 and 15 are schematic block diagrams of a UE;

FIG. 16 illustrates an example embodiment of a communication system in which embodiments of the present disclosure may be implemented;

FIG. 17 illustrates example embodiments of the host computer, base station, and UE of FIG. 16;

FIGS. 18 through 21 are flow charts that illustrate example embodiments of methods implemented in a communication system such as that of FIG. 16; and

FIG. 22 is a flow chart that illustrates the operation of a network node in accordance with an embodiment of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

In some embodiments a more general term “network node” is used and it can correspond to any type of radio network node or any network node, which communicates with a UE and/or with another network node. Examples of network nodes are radio network node, gNodeB (gNB), next generation enhanced or evolved NodeB (ng-eNB), base station (BS), NR base station, TRP (transmission reception point), Multi-Standard Radio (MSR) radio node such as MSR BS, network controller, Radio Network Controller (RNC), Base Station Controller (BSC), relay, Access Point (AP), transmission points, transmission nodes, Remote Radio Unit (RRU), Remote Radio Head (RRH), nodes in Distributed Antenna System (DAS), core network node (e.g. Mobile Switching Center (MSC), Mobility Management Entity (MME), etc.), Operations and Management (O&M) node, Operations Support System (OSS) node, Self-Organizing Network (SON) node, positioning node or location server (e.g. Evolved Serving Mobile Location Center (E-SMLC)), Minimization of Drive Test (MDT) node, test equipment (physical node or software), etc.

In some embodiments, the non-limiting term user equipment (UE) or wireless device is used and it refers to any type of wireless device communicating with a network node and/or with another UE in a cellular or mobile communication system. Examples of UE are wireless device supporting NR, target device, device to device (D2D) UE, machine type UE or UE capable of machine to machine (M2M) communication, Personal Digital Assistant (PDA), PAD, Tablet, mobile terminals, smart phone, laptop embedded equipped (LEE), laptop mounted equipment (LME), drone, USB dongles, ProSe UE, Vehicle-to-Vehicle (V2V) UE, Vehicle to Anything (V2X) UE, etc.

The term “radio node” may refer to radio network node or UE capable of transmitting radio signals or receiving radio signals or both.

The term radio access technology, or RAT, may refer to any RAT, e.g. Universal Terrestrial Radio Access (UTRA), Evolved UTRA (E-UTRA), narrow band internet of things (NB-IoT), WiFi, Bluetooth, next generation RAT, New Radio (NR), 4G, 5G, etc. Any of the equipment denoted by the term node, network node or radio network node may be capable of supporting a single or multiple RATs.

The UE performs measurements on reference signal (RS). Examples of RS are Synchronization Signal Block (SSB), Channel State Information Reference Signal (CSI-RS), Cell-specific Reference Signal (CRS), Demodulation Reference Signal (DMRS), Primary Synchronization Signal (PSS), Secondary Synchronization Signal (SSS), etc. Examples of measurements are cell identification (e.g. Physical Cell Identity (PCI) acquisition, cell detection), Reference Symbol Received Power (RSRP), Reference Symbol Received Quality (RSRQ), secondary synchronization RSRP (SS-RSRP), SS-RSRQ, Signal to Interference plus Noise Ratio (SINR), RS-SINR, SS-SINR, CSI-RSRP, CSI-RSRQ, acquisition of system information (SI), cell global ID (CGI) acquisition, Reference Signal Time Difference (RSTD), UE RX-TX time difference measurement, Radio Link Monitoring (RLM), which consists of Out of Synchronization (out of sync) detection and In Synchronization (in-sync) detection etc.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). As part of the Release 16 NR UE power saving Work Item (WI) [RP-191607], methods to improve UE power consumption are being introduced. One of the techniques to achieve improved power consumption is relaxing the UE measurement requirements, which comprises at least serving cell and/or neighbor cell measurements.

In one example, the UE can be allowed to measure on the cells that belong to different carriers less frequently compared to cells on the serving carrier. In a second example, the UE can be allowed to not measure at all on cells that belong to certain carriers under certain conditions, e.g. provided that the serving cell measurement quality is at least X decibels (dB) better than a threshold, serving cell measurement changes are within a margin, etc.

Different criteria are being introduced to the UE to evaluate and enter relaxed power saving modes where the requirements are more relaxed. These criteria may correspond to different operating scenarios. For example, some criteria are designed such that, if they are fulfilled, the UE is operating in a certain area of a cell. Other criteria are designed such that, if they are fulfilled, the UE may have a certain mobility behavior, etc. The UE enters a certain relaxation mode/state upon fulfilling a certain relaxation criteria. This means that there can be at least one state associated with each criteria, and the requirements the UE should fulfill in each state is clearly defined or is going to be defined. However, the UE behavior, in terms how the UE shall perform the measurements and what requirements the UE shall fulfill during the transition phase, i.e. when the UE changes from one state to another is undefined. This problem is addressed by the embodiments of the present disclosure described herein.

Certain aspects of the present disclosure and their embodiments may provide solutions to the aforementioned or other challenges. According to a first embodiment related to a wireless communication device which for this description is a UE, the UE determines a transition (or change or switching) between (or across) any two operational scenarios (OSs) belonging to a set (S) of OSs at a time instance (Tt), determines a set of transition requirements (R) to be fulfilled during a transition period (Tp) starting from Tt, and adapts its measurement procedure to fulfill the R requirements during Tp. In one example, the set (S) of OSs comprises at least two different operational scenarios (e.g., S1={OS1, OS2}, S2={OS1, OS3}, or S3={OS2, OS3}, where OS1 is a low mobility operational scenario, OS2 is a “not-at-cell edge” operational scenario, and OS3 is a low mobility and not-at-cell edge operational scenario. In another example, the set of OSs comprises at least three different operational scenarios (e.g., S4={OS1, OS2, OS3}.

In some embodiments, the UE further determines requirements R and Tp based on a relation between or transition across different OSs (e.g., from OS1 to OS2 or vice versa) and a set of requirements.

Some examples of the operational scenarios in which the UE can be operating comprise:
OS1: In OS1, the UE may be stationary or moving with a speed below certain threshold.
OS2: In OS2, the UE is at least not physically located at the cell edge and it may be operating in the center of the cell or close to the serving base station etc.
OS3: In OS3, the UE meets criteria for being in both OS1 and OS2.

Each of the three OSs is associated with its respective one or more criteria or conditions. The UE determines the OS in which it is operating provided that the corresponding criteria for that OS are met.

Each operational scenario is associated with at least one set of requirements.

For example:
the UE operating in OS1 is required to fulfill requirements (R), denoted as R1,
the UE operating in OS2 is required to fulfill requirements (R), denoted as R2, and
the UE operating in OS3 is required to fulfill requirements (R), denoted as R3.

As an example, assume the UE is configured to evaluate in which one of at least two different OSs in set S1 the UE is currently operating. The UE is required to apply R requirements over Tp directly upon switching between OS1 and OS2 (e.g., at time, Tt). Further assume R2 requirements are more stringent than R1 requirements (e.g., R2 measurement period is shorter than R1 measurement period). In this example, the UE then adapts its measurement procedure to fulfill the R requirements during Tp as follows.
When switching from OS1 to OS2, the UE is required to apply requirements (R) directly upon switching, i.e. starting from time instance, Tt. In this case, R=R2 and Tp=0 since UE is entering a state where the requirements are more stringent and therefore it should start measuring accordingly directly to avoid the risk of failing any procedure.
However, when switching from OS2 to OS1, the UE is required to apply requirements (R) during Tp starting from time instance, Tt. In this case, R=R2 and Tp>0. After Tp, the UE fulfills the R1 requirements. The motivation for maintaining the R2 requirements for a certain time duration (Tp) is that the UE is moving to a scenario associated with less stringent requirements (or more relaxed, e.g. longer measurement time) and it should therefore should meet R2 over certain evaluation period (Tp) before completely shifting into a less stringent (i.e., more relaxed) measurement mode. This helps the UE to complete any ongoing measurement activity in the old (source) scenario as well as avoids the risk of incorrectly entering a relaxed state. This also enables the UE to be prepared for meeting more stringent requirements (R2) in case it has to quickly revert to OS2.

Certain embodiments may provide one or more of the following technical advantage(s). Embodiments disclosed herein may enable one or more of the following advantages:
Improved power consumption—Embodiments disclosed herein may enable the UE to complete ongoing measurement activities before entering a relaxation mode.
Embodiments disclosed herein may prevent the UE from incorrectly entering a relaxed mode and thereby ensure that current ongoing operational tasks are fulfilled.
Embodiments disclosed herein define UE behavior during the transition phase in a well-defined and clear manner. This allows the network to interpret the UE measurement behavior.
Embodiments disclosed herein may enable the UE to meet requirements corresponding to more stringent operational scenario in case the UE has reverted to such scenario after the transition. This in turn ensures more robust mobility performance of the UE.

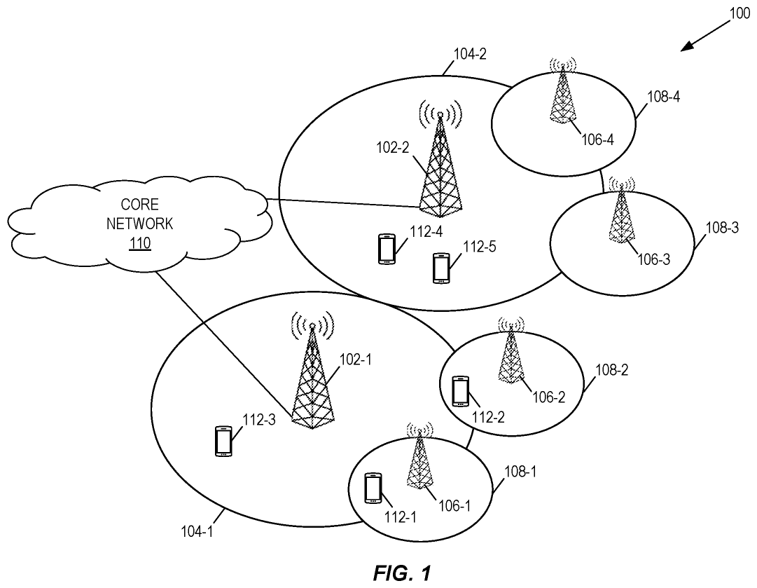

FIG. 1 illustrates one example of a cellular communications system 100 in which embodiments of the present disclosure may be implemented. In the embodiments described herein, the cellular communications system 100 is a 5G system (5GS) including a NR RAN. In this example, the RAN includes base stations 102-1 and 102-2, which in 5G NR are referred to as gNBs, controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or Remote Radio Heads (RRHs), or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5GS is referred to as the 5G core (5GC). The base stations 102 (and optionally the low power nodes 106) are connected to the core network 110.

The base stations 102 and the low power nodes 106 provide service to wireless communication devices 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs, but the present disclosure is not limited thereto.

Embodiments described herein are applicable to the following scenario. The scenario comprises at least one UE (e.g., at least one wireless device 112) which is operating in a first cell (cell1) (e.g., cell 104-1) served by a network node (NW1) (e.g., base station 102-1), and performing measurements on its serving cell (e.g., cell 104-1) and one or more neighbor cells (e.g., cell 104-2), e.g. on serving carrier and/or one or more additional carriers configured for measurements. Any additional carrier may belong to the RAT of the serving carrier frequency. In this case, if that carrier is non-serving carrier, then it is referred to as an inter-frequency carrier. The additional carrier may also belong to another RAT, in which case it is referred to as an inter-RAT carrier. The term carrier may also interchangeably be called a carrier frequency, layer, frequency layer, carrier frequency layer, etc. For consistency, the term carrier is used herein after. The said UE is further configured to evaluate in which one of at least any two different operational scenarios (OSs) the UE is currently operating:
In one example, the UE can be configured to evaluate two OSs in a first set (S1), where S1={OS1, OS2},
In a second example, the UE can be configured to evaluate two OSs in a second set (S2), where S2={OS1, OS3},
In a third example, the UE can be configured to evaluate two OSs in a third set (S3), where S3={OS2, OS3},
In a fourth example, the UE can be configured to evaluate three OSs in a fourth set (S4), where S4={OS1, OS2, OS3},

The UE operational scenario may change over time. This change or transition or switching between the OSs is determined by the UE based on the evaluation of the OSs in the configured set of OSs. Each operational scenario is associated with one set of requirements. In OS1, the UE operates in low mobility. In OS2, the UE operates in the cell center or at least not at cell edge. In OS3, the UE is expected to be of both low mobility and not at cell edge.

The embodiments described herein may also be implemented in any combination.

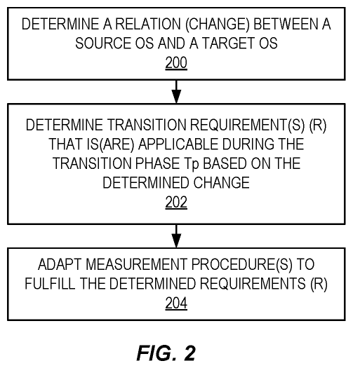

FIG. 2 is a flow chart that illustrates the operation of a UE (e.g., wireless device 112) in accordance with one embodiment of the present disclosure. As illustrated, the process performed by the UE comprises at least the following:
Step 200: The UE identifies a relation (change or switching) between a source scenario (i.e., a source OS) and a target scenario (i.e., a target OS).
Step 202: The UE determines the transition requirement(s) (R) that is(are) applicable during the transition phase Tp based on the determined change.
Step 203: The UE adapts its measurement procedures to fulfill the determined requirements (R) during the transition phase Tp.

These steps are described in detail below.

Step 200

In this step, the UE identifies a change between the source OS and the target OS. The change can be determined based on the type of criteria that is triggered, i.e. OS1, OS2, OS3. For example, the UE is expected to be in a low mobility OS (OS1) when the low mobility criteria is met, e.g. when the serving cell measurements do not change more than a certain threshold for a certain time. Similarly, the UE can be assumed to be not at cell edge (OS2) when the not cell-edge criteria is met, i.e. based on changes in RSRP and/or RSRQ measurements. The UE which fulfills OS3 criteria is expected to have higher mobility compared to scenario OS1 and physically not located at cell edge.

Each OS is also characterized by a set of requirements. For example, UEs operating in OS1 are required to fulfill the requirements corresponding to OS1 (i.e., R1). UEs operating in scenario OS2 are required to fulfill the requirements corresponding to OS2 (i.e., R2), etc. UEs operating in scenario OS3 are required to fulfill the requirements corresponding to OS3 (i.e., R3), etc. The requirements are generally different for the different OSs, especially because each OS has its own characteristics. However, in special cases, one OS can be associated with multiple set of requirements.

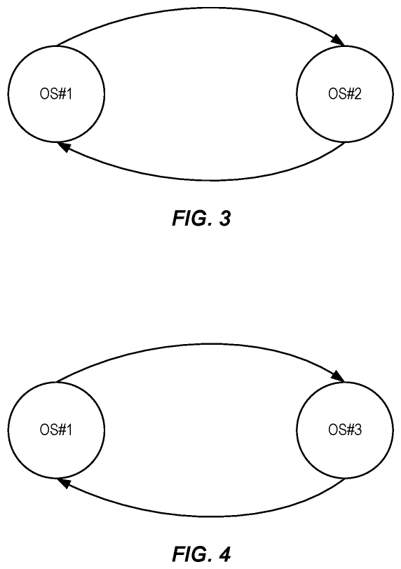

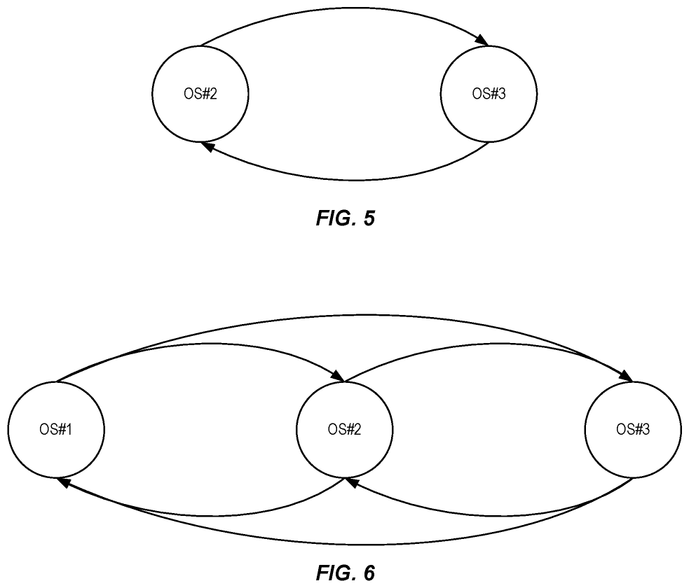

Based on the obtained information about the source OS and target OS, a relation or change is determined. Examples of transitions between different OSs in sets, S1, S2, S3, and S4 are shown in Tables 1, 2, 3, and 4 respectively. The corresponding state transitions between different OSs in sets, S1, S2, S3, and S4 are also illustrated in FIGS. 3, 4, 5, and 6 respectively. Specifically, FIG. 3 illustrates potential transitions between operational scenarios in set S1, FIG. 4 illustrates potential transitions between operational scenarios in set S2, FIG. 5 illustrates potential transitions between operational scenarios in set S3, and FIG. 6 illustrates potential transitions between and across operational scenarios in set S4.

TABLE 1
Example showing the changes or relation
between the source OS and target
OS when configured with set, S1

| Relation (change) | | |
|---|---|---|
| in set S1 | Source OS | Target OS |
| 1 | OS1 | OS2 |
| 2 | OS2 | OS1 |

TABLE 2
Example showing the changes or relation
between the source OS and target OS
when configured with set, S2

| Relation (change) | | |
|---|---|---|
| in set S2 | Source OS | Target OS |
| 1 | OS1 | OS3 |
| 2 | OS3 | OS1 |

TABLE 3
Example showing the changes or relation
between the source OS and target OS
when configured with set, S3

| Relation (change) | | |
|---|---|---|
| in set S3 | Source OS | Target OS |
| 1 | OS2 | OS3 |
| 2 | OS3 | OS2 |

TABLE 4
Example showing the changes or relation
between the source OS and target OS
when configured with set, S4

| Relation (change) | | |
|---|---|---|
| in set S4 | Source OS | Target OS |
| 1 | OS1 | OS2 |
| 2 | OS2 | OS1 |
| 3 | OS1 | OS3 |
| 4 | OS3 | OS1 |
| 5 | OS2 | OS3 |
| 6 | OS3 | OS2 |

An important characteristic of a change includes the level of stringency of the requirements between the source OS and target OS, i.e. how loose or stringent the requirements are with respect to source and target OSs. To exemplify, if R3 requirements are more stringent than R2 requirements, it means the R3 requirements are tighter than R2 and therefore more difficult to fulfill than R2 requirements. The term stringent is interchangeably called as stricter, less relaxed, tighter, more demanding, more difficult etc. To meet or fulfil more stringent requirements, the UE needs to allocate or assign more resources for performing and processing the measurements compared to the case when the UE has to meet less stringent requirements. Examples of resources are processor units, memory units, battery power etc. Examples of requirements are measurement time, measurement rate, measurement accuracy of the measurement (SS-RSRQ, SS-RSRP etc.), number of cells to measure over a measurement time, number of carriers to monitor, signal level (SINR, SS-RSRP etc.) down to which the requirements are to be met etc. Examples of measurement time are measurement period or L1 measurement period, evaluation period, cell detection time etc. In one example, a shorter measurement time is more stringent (or less relaxed) than the longer measurement time of the same type of measurement (e.g., SS-RSRP). In another example, a shorter cell detection time is more stringent than the longer cell detection time for the same type of cell, e.g. NR inter-frequency cell. In one specific example, R3 and R2 comprise the measurement period (e.g., T_{SSB_measurement_period_intra}) of a measurement (SS-RSRP) and, if the measurement period in R3 is shorter than the measurement period in R2, then the former (in R3) is considered to be more stringent than the latter (in R2). In another example, monitoring larger number of carriers is more stringent than monitoring smaller number of the same type of carriers (NR inter-frequency carriers). In another specific example, if the number of carriers (e.g., NR inter-frequency carriers) the UE is required to identify and monitor is more in R3 than in R2, then R3 requirements are said to be more stringent than R2 requirements. In yet another example, if the measurement bias in R3 (e.g., ±4 dB) is smaller than in R2 (e.g., ±6 dB), then R3 requirements are said to be more stringent than R2 requirements. In another example, a shorter measurement rate is more stringent (or less relaxed) than the longer measurement rate of the same type of measurement (e.g., SS-RSRP). For example, the measurement performed by the UE on a cell once every K1^{th} DRX cycle is more stringent (or less relaxed) than the same type of measurement performed by the UE on the cell once every K2th DRX cycle, where K1<K2, e.g. K1=2 and K2=4.

As an example, the relation 1 in Table 1 can be such that the R2 requirements are more stringent than R1 requirements which means the UE is going from OS (OS #1) associated with relaxed requirements to OS (OS #2) associated with more stringent requirements. Relation 2 in Table 1, on the other hand, means the opposite, i.e. the UE is moving to a scenario where the requirements are more relaxed than in the old scenario.

Step 202

In this step, the UE determines a set of requirements (R) it should fulfill during the transition phase Tp based on the identified change in the previous step. The transition phase is also called switching phase, switching time, switching period, re-selection time, etc. The transition phase or period (Tp) starts from a moment (Tt) at which the UE detects the transition between any two operational scenarios.

It is assumed that every change determined in the previous step is associated with a set of requirements R that applies to the UE during the transition phase. R information can be pre-defined, broadcast by serving node of the source and/or the target operating scenarios (e.g., in system information, broadcast information), or it may also be communicated using dedicated information. An example of the pre-defined requirements during transition periods to be met by the UE when it is configured with any one of different sets of OSs (e.g., S1, S2, S3 and S4) are shown in Tables 5, 6, 7, and 8 respectively. The R requirements depend on the said relation between OSs. In one example, such information may inform the UE whether the source or the target scenario requirements apply. In other example, it may contain explicit information about the requirements, e.g. delay, margin, accuracy etc. In yet another example, it may contain implicit information such as scaling factor UE should apply in the target operating scenario with respect to the requirements applied in the source operating scenario. In yet another example, it may contain a scaling factor that UE shall apply to the legacy/reference requirements during the transition phase.

TABLE 5
Example showing the mapping between the
transition requirements and change between
source- and target operating scenarios in set S1

| Relation | Source OS | Target OS | R | Tp [ms] |
|---|---|---|---|---|
| 1 | OS1 | OS2 | R12 | T12 |
| 2 | OS2 | OS1 | R21 | T21 |

T21 > T12; as special case T12 = 0 and T21 > 0.
R12 is more stringent than R21; as special case R12 = R21 = R2

TABLE 6
Example showing the mapping between the
transition requirements and change between
source- and target operating scenarios in set S2

| Relation | Source OS | Target OS | R | Tp [ms] |
|---|---|---|---|---|
| 1 | OS1 | OS3 | R13 | T13 |
| 2 | OS3 | OS1 | R31 | T31 |

T13 > T31; as special case T31 = 0 and T13 > 0.
R31 is more stringent than R13; as special case R13 = R31 = R1

TABLE 7
Example showing the mapping between the
transition requirements and change between
source- and target operating scenarios in set S3

| Relation | Source OS | Target OS | R | Tp [ms] |
|---|---|---|---|---|
| 1 | OS2 | OS3 | R23 | T23 |
| 2 | OS3 | OS2 | R32 | T32 |

T23 > T32; as special case T32 = 0 and T23 > 0.
R32 is more stringent than R23; as special case R23 = R32 = R2

TABLE 8
Example showing the mapping between the
transition requirements and change between
source- and target operating scenarios in set S4

| Relation | Source OS | Target OS | R | Tp [ms] |
|---|---|---|---|---|
| 1 | OS1 | OS2 | R12′ | T12′ |
| 2 | OS2 | OS1 | R21′ | T21′ |
| 3 | OS1 | OS3 | R13′ | T13′ |
| 4 | OS3 | OS1 | R31′ | T31′ |
| 5 | OS2 | OS3 | R23′ | T23′ |
| 6 | OS3 | OS2 | R32′ | T32′ |

T21′ > T12′; T13′ > T31′ and T23′ > T32′; as special case: T12′ = T12;
T21′ = T21; T13′ = T13; T31′ = T31 and T23′ = T23 and T32′ = T32.

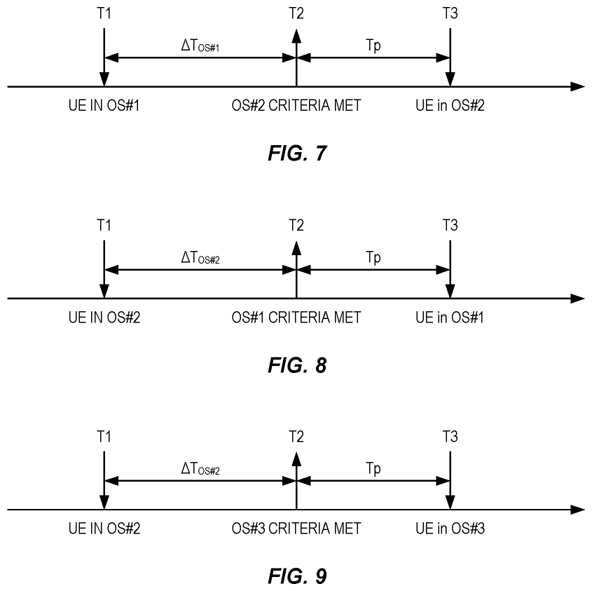

Some aspects of the embodiments described herein are described using an example scenario as illustrated in FIG. 7. In this example, it is assumed that the UE is configured to evaluate the OSs in set S1. This figure shows that the UE starts in OS1 at time T1 and the criteria for entering OS2 is fulfilled at time T2. During time period ΔT_{OS1}, the UE applies the requirements associated with OS1, i.e. R1. The time between T2 and T3 is called the transition phase (Tp), and the requirements that apply during this period is called R. From time T3, the UE is operating fully in scenario OS2 in which case all requirements that are specific to state OS2 apply.

The R requirements applied during Tp depend on the type of change or relation between source OS and target OS. In this example, since the UE is moving from a scenario (OS1) where the requirements are expected to be more loose/relaxed to a scenario (OS2) where the requirements are expected to be more stringent, R=R2 and the UE starts applying R2 requirements directly after entering the scenario OS2 at Tt. In this case, Tp becomes 0. The reasons for triggering this change in operating scenarios and thereby also the requirements could be that the UE is no longer stationary, or it may have started to move faster, because of changes in its geographical location, changes in the radio conditions (e.g., radio measurements) etc. Therefore, the UE applies the new requirements directly to avoid the risk of failing any of its operational tasks.

In a different example in FIG. 8, the UE is moving from OS2 to OS1, i.e. from a scenario where the requirements are stringent to a scenario where the requirements are more relaxed. In this case, the UE operates in OS1 but fulfills the requirements corresponding to OS2 during Tp, i.e. Rp=R2. The motivation is that the UE is moving from a scenario where requirements are more stringent to a state where the requirements are more relaxed, such relaxed requirements may comprise (but not limited to), not performing any measurements at all, measuring much less frequently-, measuring over longer time duration-, fulfilling less accurate measurement performances compared to the requirements (R2) of OS1, etc. There are different advantages in following this behavior. One advantage is that it gives an opportunity for the UEs to complete the already on-going measurement activities. Typically, measurements are carried out by UE taking numerous samples and averaging in time-domain. If the UE has suddenly entered a scenario where it is no longer required to measure anything at all or where it is allowed to measure much more sparsely in time, the UE may have to discard already on-going measurement activities which is inefficient from a power consumption perspective.

In yet another example illustrated in FIG. 9, the UE moving from a scenario where the UE is operating in moderate/high-speed (OS2) to a scenario with limited mobility and not at cell-edge (OS3). In this example, it is assumed that the UE is configured to evaluate the OSs in set S3. In this case, the R3 requirements are more relaxed (i.e., UE is not expected measure on any of its neighbor cells at all) compared to R2. Since going from a state where measurements are performed on periodic basis to a state where UE is not measuring any neighbor cells at all can have various consequences, both in terms of UE power consumption but also on the procedures as explained in previous examples. Therefore, the UE applies the R2 requirements as the requirements R during Tp. The same UE behavior would also apply when moving from OS1 to OS3 when configured to evaluate the OSs in set S2.

On the other hand, when UE is moving from OS3 to any other operating scenarios where the requirements are more stringent (OS1 and OS2), it is reasonable to assume Tp=0, i.e. it shall apply the requirements of the target operating scenario directly upon entering that scenario.

Another advantage following the methods disclosed in this UE embodiment is that the criteria for entering or changing different relaxed operating scenarios are based on one or more measurement thresholds. However, the measurements are generally subject to bias, and by applying the R requirements during the transition phase Tp, the UE can avoid the situation of incorrectly entering a more relaxed operating scenario.

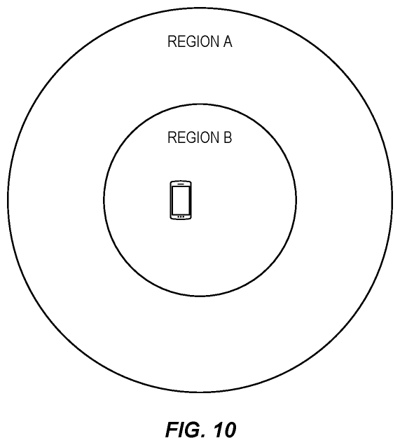

Yet another reason for operating using R during the transition phase is that UE may incorrectly assume that it has moved from a scenario associated with stringent requirements to a scenario associated with less stringent requirement without causing significant change in the measurement to be detected by the criteria, as shown in FIG. 10. In this figure, the UEs which are moving within region B may still move freely within that region without causing significant changes in the measurements. Consequently, the criteria associated with region B may incorrectly be fulfilled and UE may attempt to fulfill the OS1 requirements (R1) while operating in OS2 and hence fail to fulfill the requirements. The use of R over the transition period Tp avoids or reduces this risk.

In yet another aspect of the UE embodiment, the UE (e.g., always) continues to operate based on the requirements associated with the source operating scenario during the transition phase regardless of the relation between source and target scenarios. This means, R=R1 during Tp in the example scenario in FIGS. 7 and 9. The transition phase/period is similar to an evaluation period, wherein the UE does not switch immediately upon fulfilling the target scenario criteria, instead it continues to operate in the target scenario assuming the requirements of the source scenario. This UE behavior reduces the risk of UE failing to operate in the new state, e.g. due to not being able to fulfill those requirements due to insufficient measurement opportunities. This UE behavior further avoids that UE incorrectly enters a less suitable state, e.g. due to sudden changes in the operating scenarios.

Step 204

In this step, the UE adapts a measurement procedure based on the determined measurement requirements in the previous step. The adaptation of the measurement procedure comprising one or more of the following:
deriving the measurement requirements that apply during the transition phase based on the determined relation between the source- and target operating scenarios.
performing one or more measurements while meeting the derived measurement requirements,
using the results of the performed measurements for one or more operational tasks. The operational tasks comprise, using the measurement results for evaluating different criteria (e.g., for different types of cell change such as cell re-selection, handover, RRC re-establishment), reporting those measurements or result of those measurements to different nodes (e.g., NW1, another UE), etc.

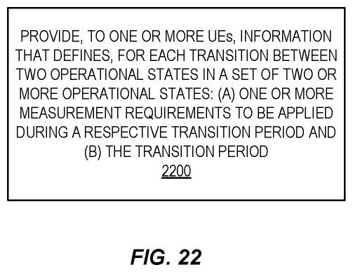

FIG. 22 is a flow chart that illustrates the operation of a network node (e.g., a base station 102 or radio access node that performs at least some of the functions of the base station 102) in accordance with an embodiment of the present disclosure. As illustrated, the network node provides, to one or more UEs 112, information that defines, for each transition between two operational states in a set of two or more operational states: (a) one or more measurement requirements that are applicable during a transition period and (b) the transition period (step 2200). As discussed above, this information may be provided by broadcast transmission or dedicated signaling. Further, of the details provided above regarding the operational states, the measurement requirements, and the transition period are equally applicable here and are not repeated to sake of being concise.

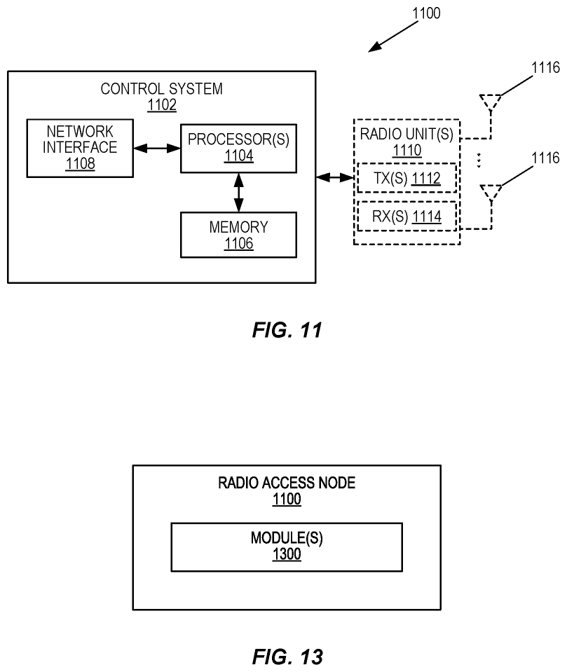

FIG. 11 is a schematic block diagram of a radio access node 1100 according to some embodiments of the present disclosure. Optional features are represented by dashed boxes. The radio access node 1100 may be, for example, a base station 102 or 106 or a network node that implements all or part of the functionality of the base station 102 or gNB described herein. As illustrated, the radio access node 1100 includes a control system 1102 that includes one or more processors 1104 (e.g., Central Processing Units (CPUs), Application Specific Integrated Circuits (ASICs), Field Programmable Gate Arrays (FPGAs), and/or the like), memory 1106, and a network interface 1108. The one or more processors 1104 are also referred to herein as processing circuitry. In addition, the radio access node 1100 may include one or more radio units 1110 that each includes one or more transmitters 1112 and one or more receivers 1114 coupled to one or more antennas 1116. The radio units 1110 may be referred to or be part of radio interface circuitry. In some embodiments, the radio unit(s) 1110 is external to the control system 1102 and connected to the control system 1102 via, e.g., a wired connection (e.g., an optical cable). However, in some other embodiments, the radio unit(s) 1110 and potentially the antenna(s) 1116 are integrated together with the control system 1102. The one or more processors 1104 operate to provide one or more functions of a radio access node 1100 as described herein. In some embodiments, the function(s) are implemented in software that is stored, e.g., in the memory 1106 and executed by the one or more processors 1104.

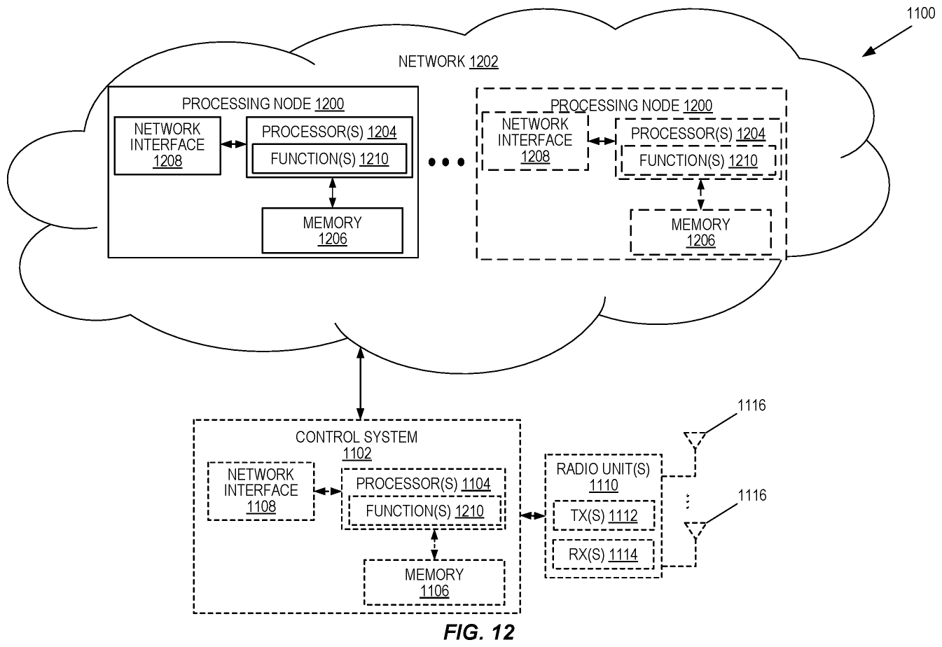

FIG. 12 is a schematic block diagram that illustrates a virtualized embodiment of the radio access node 1100 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1100 in which at least a portion of the functionality of the radio access node 1100 is implemented as a virtual component(s) (e.g., via a virtual machine(s) executing on a physical processing node(s) in a network(s)). As illustrated, in this example, the radio access node 1100 may include the control system 1102 and/or the one or more radio units 1110, as described above. The control system 1102 may be connected to the radio unit(s) 1110 via, for example, an optical cable or the like. The radio access node 1100 includes one or more processing nodes 1200 coupled to or included as part of a network(s) 1202. If present, the control system 1102 or the radio unit(s) are connected to the processing node(s) 1200 via the network 1202. Each processing node 1200 includes one or more processors 1204 (e.g., CPUs, ASICs, FPGAs, and/or the like), memory 1206, and a network interface 1208.

In this example, functions 1210 of the radio access node 1100 described herein are implemented at the one or more processing nodes 1200 or distributed across the one or more processing nodes 1200 and the control system 1102 and/or the radio unit(s) 1110 in any desired manner. In some particular embodiments, some or all of the functions 1210 of the radio access node 1100 described herein are implemented as virtual components executed by one or more virtual machines implemented in a virtual environment(s) hosted by the processing node(s) 1200. As will be appreciated by one of ordinary skill in the art, additional signaling or communication between the processing node(s) 1200 and the control system 1102 is used in order to carry out at least some of the desired functions 1210. Notably, in some embodiments, the control system 1102 may not be included, in which case the radio unit(s) 1110 communicate directly with the processing node(s) 1200 via an appropriate network interface(s).

In some embodiments, a computer program including instructions which, when executed by at least one processor, causes the at least one processor to carry out the functionality of radio access node 1100 or a node (e.g., a processing node 1200) implementing one or more of the functions 1210 of the radio access node 1100 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the radio access node 1100 according to some other embodiments of the present disclosure. The radio access node 1100 includes one or more modules 1300, each of which is implemented in software. The module(s) 1300 provide the functionality of the radio access node 1100 described herein. This discussion is equally applicable to the processing node 1200 of FIG. 12 where the modules 1300 may be implemented at one of the processing nodes 1200 or distributed across multiple processing nodes 1200 and/or distributed across the processing node(s) 1200 and the control system 1102.

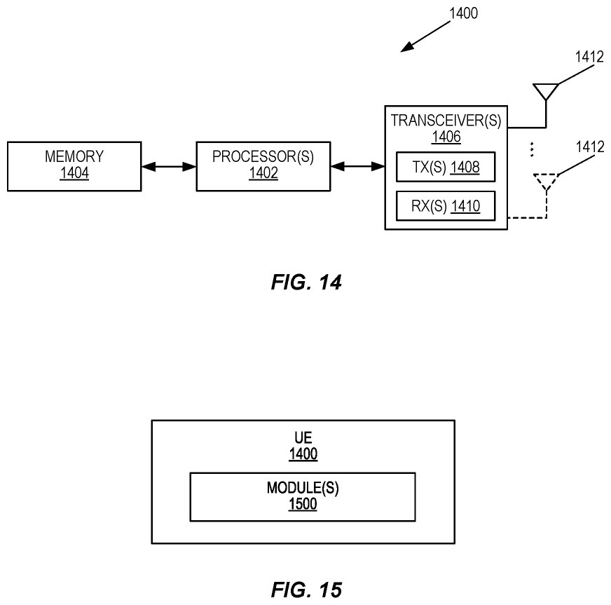

FIG. 14 is a schematic block diagram of a wireless communication device 1400 (e.g., wireless device 112 or UE) according to some embodiments of the present disclosure. As illustrated, the wireless communication device 1400 includes one or more processors 1402 (e.g., CPUs, ASICs, FPGAs, and/or the like), memory 1404, and one or more transceivers 1406 each including one or more transmitters 1408 and one or more receivers 1410 coupled to one or more antennas 1412. The transceiver(s) 1406 includes radio-front end circuitry connected to the antenna(s) 1412 that is configured to condition signals communicated between the antenna(s) 1412 and the processor(s) 1402, as will be appreciated by on of ordinary skill in the art. The processors 1402 are also referred to herein as processing circuitry. The transceivers 1406 are also referred to herein as radio circuitry. In some embodiments, the functionality of the wireless communication device 1400 described above (e.g., the functionality of the UE described above, e.g., with respect to FIG. 2) may be fully or partially implemented in software that is, e.g., stored in the memory 1404 and executed by the processor(s) 1402. Note that the wireless communication device 1400 may include additional components not illustrated in FIG. 14 such as, e.g., one or more user interface components (e.g., an input/output interface including a display, buttons, a touch screen, a microphone, a speaker(s), and/or the like and/or any other components for allowing input of information into the wireless communication device 1400 and/or allowing output of information from the wireless communication device 1400), a power supply (e.g., a battery and associated power circuitry), etc.

In some embodiments, a computer program including instructions which, when executed by at least one processor, causes the at least one processor to carry out the functionality of the wireless communication device 1400 according to any of the embodiments described herein (e.g., the functionality of the UE described above, e.g., with respect to FIG. 2) is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 15 is a schematic block diagram of the wireless communication device 1400 according to some other embodiments of the present disclosure. The wireless communication device 1400 includes one or more modules 1500, each of which is implemented in software. The module(s) 1500 provide the functionality of the wireless communication device 1400 described herein (e.g., the functionality of the UE described above, e.g., with respect to FIG. 2).

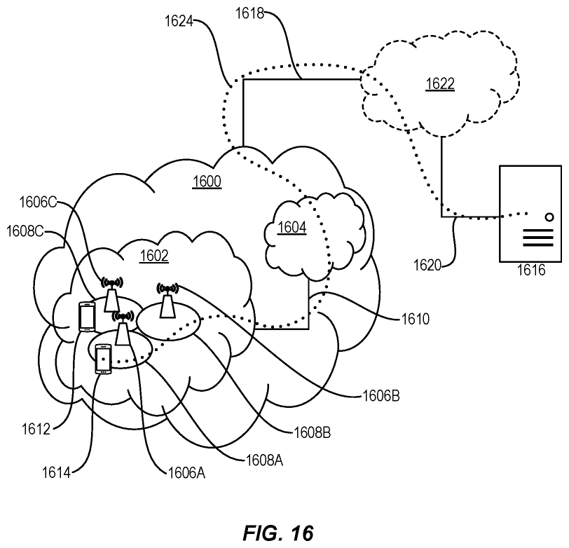

With reference to FIG. 16, in accordance with an embodiment, a communication system includes a telecommunication network 1600, such as a 3GPP-type cellular network, which comprises an access network 1602, such as a RAN, and a core network 1604. The access network 1602 comprises a plurality of base stations 1606A, 1606B, 1606C, such as Node Bs, eNBs, gNBs, or other types of wireless Access Points (APs), each defining a corresponding coverage area 1608A, 1608B, 1608C. Each base station 1606A, 1606B, 1606C is connectable to the core network 1604 over a wired or wireless connection 1610. A first UE 1612 located in coverage area 1608C is configured to wirelessly connect to, or be paged by, the corresponding base station 1606C. A second UE 1614 in coverage area 1608A is wirelessly connectable to the corresponding base station 1606A. While a plurality of UEs 1612, 1614 are illustrated in this example, the disclosed embodiments are equally applicable to a situation where a sole UE is in the coverage area or where a sole UE is connecting to the corresponding base station 1606.

The telecommunication network 1600 is itself connected to a host computer 1616, which may be embodied in the hardware and/or software of a standalone server, a cloud-implemented server, a distributed server, or as processing resources in a server farm. The host computer 1616 may be under the ownership or control of a service provider, or may be operated by the service provider or on behalf of the service provider. Connections 1618 and 1620 between the telecommunication network 1600 and the host computer 1616 may extend directly from the core network 1604 to the host computer 1616 or may go via an optional intermediate network 1622. The intermediate network 1622 may be one of, or a combination of more than one of, a public, private, or hosted network; the intermediate network 1622, if any, may be a backbone network or the Internet; in particular, the intermediate network 1622 may comprise two or more sub-networks (not shown).

The communication system of FIG. 16 as a whole enables connectivity between the connected UEs 1612, 1614 and the host computer 1616. The connectivity may be described as an Over-the-Top (OTT) connection 1624. The host computer 1616 and the connected UEs 1612, 1614 are configured to communicate data and/or signaling via the OTT connection 1624, using the access network 1602, the core network 1604, any intermediate network 1622, and possible further infrastructure (not shown) as intermediaries. The OTT connection 1624 may be transparent in the sense that the participating communication devices through which the OTT connection 1624 passes are unaware of routing of uplink and downlink communications. For example, the base station 1606 may not or need not be informed about the past routing of an incoming downlink communication with data originating from the host computer 1616 to be forwarded (e.g., handed over) to a connected UE 1612. Similarly, the base station 1606 need not be aware of the future routing of an outgoing uplink communication originating from the UE 1612 towards the host computer 1616.

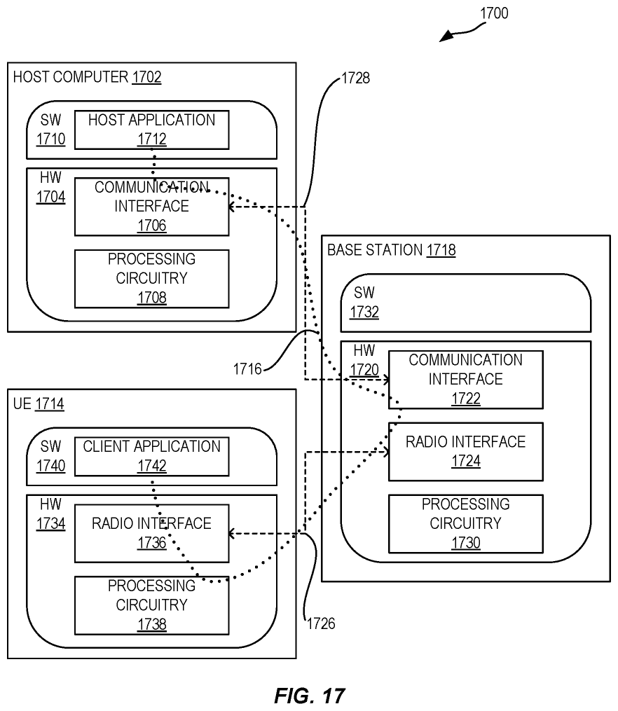

Example implementations, in accordance with an embodiment, of the UE, base station, and host computer discussed in the preceding paragraphs will now be described with reference to FIG. 17. In a communication system 1700, a host computer 1702 comprises hardware 1704 including a communication interface 1706 configured to set up and maintain a wired or wireless connection with an interface of a different communication device of the communication system 1700. The host computer 1702 further comprises processing circuitry 1708, which may have storage and/or processing capabilities. In particular, the processing circuitry 1708 may comprise one or more programmable processors, ASICs, FPGAs, or combinations of these (not shown) adapted to execute instructions. The host computer 1702 further comprises software 1710, which is stored in or accessible by the host computer 1702 and executable by the processing circuitry 1708. The software 1710 includes a host application 1712. The host application 1712 may be operable to provide a service to a remote user, such as a UE 1714 connecting via an OTT connection 1716 terminating at the UE 1714 and the host computer 1702. In providing the service to the remote user, the host application 1712 may provide user data which is transmitted using the OTT connection 1716.

The communication system 1700 further includes a base station 1718 provided in a telecommunication system and comprising hardware 1720 enabling it to communicate with the host computer 1702 and with the UE 1714. The hardware 1720 may include a communication interface 1722 for setting up and maintaining a wired or wireless connection with an interface of a different communication device of the communication system 1700, as well as a radio interface 1724 for setting up and maintaining at least a wireless connection 1726 with the UE 1714 located in a coverage area (not shown in FIG. 17) served by the base station 1718. The communication interface 1722 may be configured to facilitate a connection 1728 to the host computer 1702. The connection 1728 may be direct or it may pass through a core network (not shown in FIG. 17) of the telecommunication system and/or through one or more intermediate networks outside the telecommunication system. In the embodiment shown, the hardware 1720 of the base station 1718 further includes processing circuitry 1730, which may comprise one or more programmable processors, ASICs, FPGAs, or combinations of these (not shown) adapted to execute instructions. The base station 1718 further has software 1732 stored internally or accessible via an external connection.

The communication system 1700 further includes the UE 1714 already referred to. The UE's 1714 hardware 1734 may include a radio interface 1736 configured to set up and maintain a wireless connection 1726 with a base station serving a coverage area in which the UE 1714 is currently located. The hardware 1734 of the UE 1714 further includes processing circuitry 1738, which may comprise one or more programmable processors, ASICs, FPGAs, or combinations of these (not shown) adapted to execute instructions. The UE 1714 further comprises software 1740, which is stored in or accessible by the UE 1714 and executable by the processing circuitry 1738. The software 1740 includes a client application 1742. The client application 1742 may be operable to provide a service to a human or non-human user via the UE 1714, with the support of the host computer 1702. In the host computer 1702, the executing host application 1712 may communicate with the executing client application 1742 via the OTT connection 1716 terminating at the UE 1714 and the host computer 1702. In providing the service to the user, the client application 1742 may receive request data from the host application 1712 and provide user data in response to the request data. The OTT connection 1716 may transfer both the request data and the user data. The client application 1742 may interact with the user to generate the user data that it provides.

It is noted that the host computer 1702, the base station 1718, and the UE 1714 illustrated in FIG. 17 may be similar or identical to the host computer 1616, one of the base stations 1606A, 1606B, 1606C, and one of the UEs 1612, 1614 of FIG. 16, respectively. This is to say, the inner workings of these entities may be as shown in FIG. 17 and independently, the surrounding network topology may be that of FIG. 16.

In FIG. 17, the OTT connection 1716 has been drawn abstractly to illustrate the communication between the host computer 1702 and the UE 1714 via the base station 1718 without explicit reference to any intermediary devices and the precise routing of messages via these devices. The network infrastructure may determine the routing, which may be configured to hide from the UE 1714 or from the service provider operating the host computer 1702, or both. While the OTT connection 1716 is active, the network infrastructure may further take decisions by which it dynamically changes the routing (e.g., on the basis of load balancing consideration or reconfiguration of the network).

The wireless connection 1726 between the UE 1714 and the base station 1718 is in accordance with the teachings of the embodiments described throughout this disclosure. One or more of the various embodiments improve the performance of OTT services provided to the UE 1714 using the OTT connection 1716, in which the wireless connection 1726 forms the last segment. More precisely, the teachings of these embodiments may improve, e.g., power consumption and thereby provide benefits such as, e.g., extended battery lifetime.

A measurement procedure may be provided for the purpose of monitoring data rate, latency, and other factors on which the one or more embodiments improve. There may further be an optional network functionality for reconfiguring the OTT connection 1716 between the host computer 1702 and the UE 1714, in response to variations in the measurement results. The measurement procedure and/or the network functionality for reconfiguring the OTT connection 1716 may be implemented in the software 1710 and the hardware 1704 of the host computer 1702 or in the software 1740 and the hardware 1734 of the UE 1714, or both. In some embodiments, sensors (not shown) may be deployed in or in association with communication devices through which the OTT connection 1716 passes; the sensors may participate in the measurement procedure by supplying values of the monitored quantities exemplified above, or supplying values of other physical quantities from which the software 1710, 1740 may compute or estimate the monitored quantities. The reconfiguring of the OTT connection 1716 may include message format, retransmission settings, preferred routing, etc.; the reconfiguring need not affect the base station 1718, and it may be unknown or imperceptible to the base station 1718. Such procedures and functionalities may be known and practiced in the art. In certain embodiments, measurements may involve proprietary UE signaling facilitating the host computer 1702's measurements of throughput, propagation times, latency, and the like. The measurements may be implemented in that the software 1710 and 1740 causes messages to be transmitted, in particular empty or ‘dummy’ messages, using the OTT connection 1716 while it monitors propagation times, errors, etc.

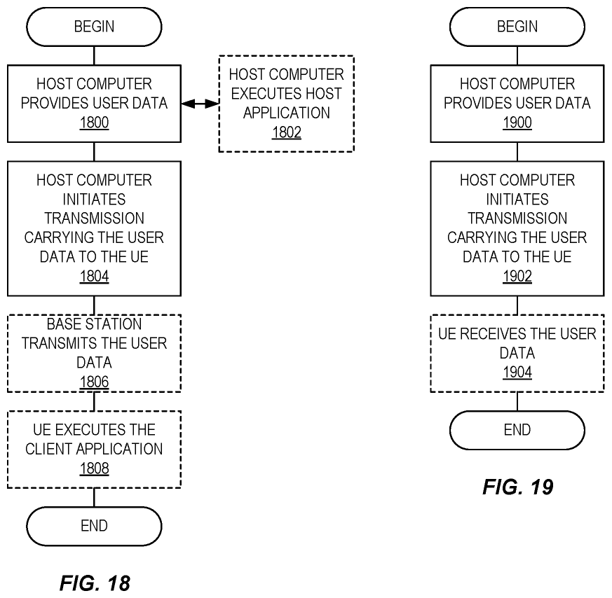

FIG. 18 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 18 will be included in this section. In step 1800, the host computer provides user data. In sub-step 1802 (which may be optional) of step 1800, the host computer provides the user data by executing a host application. In step 1804, the host computer initiates a transmission carrying the user data to the UE. In step 1806 (which may be optional), the base station transmits to the UE the user data which was carried in the transmission that the host computer initiated, in accordance with the teachings of the embodiments described throughout this disclosure. In step 1808 (which may also be optional), the UE executes a client application associated with the host application executed by the host computer.

FIG. 19 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 19 will be included in this section. In step 1900 of the method, the host computer provides user data. In an optional sub-step (not shown) the host computer provides the user data by executing a host application. In step 1902, the host computer initiates a transmission carrying the user data to the UE. The transmission may pass via the base station, in accordance with the teachings of the embodiments described throughout this disclosure. In step 1904 (which may be optional), the UE receives the user data carried in the transmission.

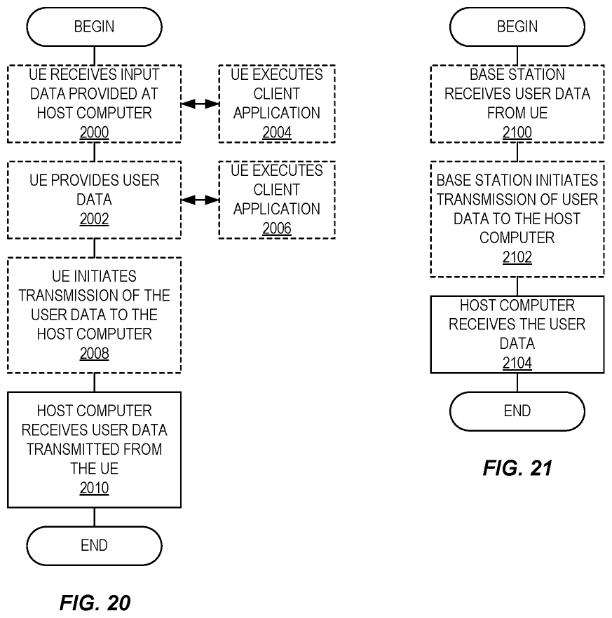

FIG. 20 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 20 will be included in this section. In step 2000 (which may be optional), the UE receives input data provided by the host computer. Additionally or alternatively, in step 2002, the UE provides user data. In sub-step 2004 (which may be optional) of step 2000, the UE provides the user data by executing a client application. In sub-step 2006 (which may be optional) of step 2002, the UE executes a client application which provides the user data in reaction to the received input data provided by the host computer. In providing the user data, the executed client application may further consider user input received from the user. Regardless of the specific manner in which the user data was provided, the UE initiates, in sub-step 2008 (which may be optional), transmission of the user data to the host computer. In step 2010 of the method, the host computer receives the user data transmitted from the UE, in accordance with the teachings of the embodiments described throughout this disclosure.

FIG. 21 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 21 will be included in this section. In step 2100 (which may be optional), in accordance with the teachings of the embodiments described throughout this disclosure, the base station receives user data from the UE.

In step 2102 (which may be optional), the base station initiates transmission of the received user data to the host computer. In step 2104 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

### Group A Embodiments

Embodiment 1: A method performed by a wireless device, the method comprising: determining (200) that the wireless device transitions from a first operational scenario to a second operational scenario; determining (202) one or more requirements that are applicable during a transition period based on the determined transition; and adapting (204) one or more measurement procedures to fulfill the one or more requirements during the transition period.

Embodiment 2: The method of embodiment 1 wherein the first operational scenario is associated with one or more first requirements, the second operational scenario is associated with one or more second requirements, and determining (202) the one or more requirements that are applicable during the transition period comprises selecting either the one or more first requirements or the one or more second requirements, based on whether the one or more first requirements are more or less stringent than the one or more second requirements.

Embodiment 3: The method of embodiment 1 wherein: the first operational scenario and the second operational scenario are comprised in a set of two or more operational scenarios; one or more requirements are predefined or preconfigured for each possible transition between operational scenarios in the set of two or more operational scenarios; and determining (202) the one or more requirements that are applicable during the transition period comprises selecting the one or more predefined or preconfigured requirements for the determined transition, the determined transition being one of the possible transitions between operational scenarios in the set of two or more operational scenarios.

Embodiment 4: The method of any one of embodiments 1 to 3 wherein the first operational scenario is a low mobility scenario, a non-cell-edge scenario, or a low mobility and non-cell-edge scenario.

Embodiment 5: The method of embodiments 1 to 4 wherein the second operational scenario is a low mobility scenario, a non-cell-edge scenario, or a low mobility and non-cell-edge scenario, and is a different operational scenario than the first operational scenario.

Embodiment 6: The method of any of the previous embodiments, further comprising: providing user data; and forwarding the user data to a host computer via the transmission to the base station.

### Group C Embodiments

Embodiment 7: A wireless device comprising: processing circuitry configured to perform any of the steps of any of the Group A embodiments; and power supply circuitry configured to supply power to the wireless device.

Embodiment 8: A User Equipment, UE, comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 9: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.

Embodiment 10: The communication system of the previous embodiment, wherein the cellular network further includes a base station configured to communicate with the UE.

Embodiment 11: The communication system of the previous 2 embodiments, wherein: the processing circuitry of the host computer is configured to execute a host application, thereby providing the user data; and the UE's processing circuitry is configured to execute a client application associated with the host application.

Embodiment 12: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.

Embodiment 13: The method of the previous embodiment, further comprising at the UE, receiving the user data from the base station.

Embodiment 14: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of the Group A embodiments.

Embodiment 15: The communication system of the previous embodiment, further including the UE.

Embodiment 16: The communication system of the previous 2 embodiments, further including the base station, wherein the base station comprises a radio interface configured to communicate with the UE and a communication interface configured to forward to the host computer the user data carried by a transmission from the UE to the base station.

Embodiment 17: The communication system of the previous 3 embodiments, wherein: the processing circuitry of the host computer is configured to execute a host application; and the UE's processing circuitry is configured to execute a client application associated with the host application, thereby providing the user data.

Embodiment 18: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 19: A method implemented in a communication system including a host computer, a base station, and a User Equipment, UE, the method comprising: at the host computer, receiving user data transmitted to the base station from the UE, wherein the UE performs any of the steps of any of the Group A embodiments.

Embodiment 20: The method of the previous embodiment, further comprising, at the UE, providing the user data to the base station.

Embodiment 21: The method of the previous 2 embodiments, further comprising: at the UE, executing a client application, thereby providing the user data to be transmitted; and at the host computer, executing a host application associated with the client application.

Embodiment 22: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 23: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.

Embodiment 24: The method of the previous embodiment, further comprising at the base station, receiving the user data from the UE.

Embodiment 25: The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
ASIC Application Specific Integrated Circuit
AUSF Authentication Server Function
CPU Central Processing Unit
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IoT Internet of Things
IP Internet Protocol
LTE Long Term Evolution
MME Mobility Management Entity
MTC Machine Type Communication
NEF Network Exposure Function
NF Network Function
NR New Radio
NRF Network Function Repository Function
NSSF Network Slice Selection Function
OTT Over-the-Top
PC Personal Computer
PCF Policy Control Function
P-GW Packet Data Network Gateway
QoS Quality of Service
RAM Random Access Memory
RAN Radio Access Network
ROM Read Only Memory
RRH Remote Radio Head
RTT Round Trip Time
SCEF Service Capability Exposure Function
SMF Session Management Function
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1. A method performed by a wireless device, the method comprising:
determining that a transition of the wireless device from a first operational scenario to a second operational scenario has occurred;
determining one or more measurement requirements that are applicable during a transition period based on the determined transition, wherein the transition period starts at a moment that the wireless device determines that the transition from the first operational scenario to the second operational scenario has occurred and ends at a time at which the wireless device is to apply a set of measurement requirements associated to the second operational scenario; and
adapting one or more measurement procedures to fulfill the one or more measurement requirements during the transition period.

2. The method of claim 1 wherein the first operational scenario is associated with one or more first requirements, the second operational scenario is associated with one or more second requirements, and determining the one or more requirements that are applicable during the transition period comprises selecting either the one or more first requirements or the one or more second requirements based on whether the one or more first requirements are more or less stringent than the one or more second requirements.

3. The method of claim 1 wherein:
the first operational scenario and the second operational scenario are comprised in a set of two or more operational scenarios;
one or more requirements are predefined or preconfigured for each possible transition between operational scenarios in the set of two or more operational scenarios; and
determining the one or more requirements that are applicable during the transition period comprises selecting the one or more predefined or preconfigured requirements for the determined transition, the determined transition being one of the possible transitions between operational scenarios in the set of two or more operational scenarios.

4. The method of claim 1 wherein the first operational scenario is associated with one or more first requirements, the second operational scenario is associated with one or more second requirements, and determining the one or more requirements that are applicable during the transition period comprises selecting the one or more first requirements regardless of whether the one or more first requirements are more or less stringent than the one or more second requirements.

5. The method of claim 1 wherein the first operational scenario is one of a set of two or more operational scenarios, the second operational scenario is a different one of the set of two or more operational scenarios.

6. The method of claim 5 wherein the set of two or more operational scenarios comprises a low mobility scenario and a non-cell-edge scenario.

7. The method of claim 5 wherein the set of two or more operational scenarios comprises a low mobility scenario, a non-cell-edge scenario, and a low mobility and non-cell-edge scenario.

8. The method of claim 1 wherein a first set of measurement requirements associated to the first operational scenario is more stringent than a second set of measurement requirements associated to the second operational scenario, and the transition period is an amount of time that is greater than zero.

9. The method of claim 1 wherein a first set of measurement requirements associated to the first operational scenario is less stringent than a second set of measurement requirements associated to the second operational scenario, and the transition period is an amount of time that is equal to zero.

10. The method of claim 1 wherein a first set of measurement requirements associated to the first operational scenario is less stringent than a second set of measurement requirements associated to the second operational scenario, and the transition period is an amount of time that is greater than zero.

11. The method of claim 1 wherein the one or more measurement requirements to apply during the transition period and the one or more measurement procedures are associated to measurements performed on a serving carrier of the wireless device and measurements performed on one or more non-serving carriers.

12. The method of claim 1 wherein the one or more measurement requirements to apply during the transition period comprise: (a) a measurement time, (b) a measurement rate, (c) a measurement accuracy, (d) a number of cells to measure over a measurement time, (e) a number of carriers to monitor, (f) a signal level down to which the one or more measurement requirements are to be met, or (g) a combination of any two or more of (a)-(f).

13. The method of claim 1 wherein the one or more measurement requirements to apply during the transition period for the determined transition from the first operational scenario to the second operational scenario are predefined, received via a broadcast from a network node, or received via dedicated signaling from a network node.

14. (canceled)

15. (canceled)

16. A wireless device comprising:
one or more transmitters;
one or more receivers; and
processing circuitry associated with the one or more transmitters and the one or more receivers, the processing circuitry configured to cause the wireless device to:
determine that a transition of the wireless device from a first operational scenario to a second operational scenario has occurred;
determine one or more measurement requirements that are applicable during a transition period based on the determined transition, wherein the transition period starts at a moment that the wireless device determines that the transition from the first operational scenario to the second operational scenario has occurred and ends at a time at which the wireless device is to apply a set of measurement requirements associated to the second operational scenario; and
adapt one or more measurement procedures to fulfill the one or more measurement requirements during the transition period.

17-19. (canceled)

20. A non-transitory computer readable medium comprising instructions executable by processing circuitry of a wireless device to thereby cause the wireless device to:
determine that a transition of the wireless device from a first operational scenario to a second operational scenario has occurred;
determine one or more measurement requirements that are applicable during a transition period based on the determined transition, wherein the transition period starts at a moment that the wireless device determines that the transition from the first operational scenario to the second operational scenario has occurred and ends at a time at which the wireless device is to apply a set of measurement requirements associated to the second operational scenario; and
adapt one or more measurement procedures to fulfill the one or more measurement requirements during the transition period.

21. A method performed by a network node, the method comprising:
providing, to one or more wireless devices, information that defines, for each transition between two operational states in a set of two or more operational states:
one or more measurement requirements that are applicable during a transition period; and
the transition period.

22. The method of claim 21 wherein the set of two or more operational scenarios comprises a low mobility scenario and a non-cell-edge scenario.

23. The method of claim 21 wherein the set of two or more operational scenarios comprises a low mobility scenario, a non-cell-edge scenario, and a low mobility and non-cell-edge scenario.

24. The method of claim 21 wherein, for each transition, the one or more requirements that are applicable during the transition period for the transition comprise either one or more first requirements associated to a source operational scenario for the transition or one or more second requirements associated to a target operational scenario for the transition depending on whether the one or more first requirements are more or less stringent than the one or more second requirements.

25. The method of claim 21 wherein, for each transition, the one or more requirements that are applicable during the transition period for the transition comprise one or more first requirements associated to a source operational scenario for the transition regardless of whether the one or more first requirements are more or less stringent than one or more second requirements associated to a target operational scenario for the transition.

26. The method of claim 21 wherein, for each transition for which a first set of measurement requirements associated to a source operational scenario is more stringent than a second set of measurement requirements associated to a second target operational scenario for the transition, the transition period is an amount of time that is greater than zero.

27. The method of claim 21 wherein, for each transition for which a first set of measurement requirements associated to a source operational scenario is less stringent than a second set of measurement requirements associated to a second target operational scenario for the transition, the transition period is an amount of time that is equal to zero.

28. The method of claim 21 wherein, for each transition for which a first set of measurement requirements associated to a source operational scenario is less stringent than a second set of measurement requirements associated to a second target operational scenario for the transition, the transition period is an amount of time that is greater than zero.

29. The method of claim 21 wherein, for each transition, the one or more measurement requirements to apply during the transition period are associated to measurements performed on a serving carrier of the wireless device and measurements performed on one or more non-serving carriers.

30. The method of claim 21 wherein, for each transition, the one or more measurement requirements to apply during the transition period comprise: (a) a measurement time, (b) a measurement rate, (c) a measurement accuracy, (d) a number of cells to measure over a measurement time, (e) a number of carriers to monitor, (f) a signal level down to which the one or more measurement requirements are to be met, or (g) a combination of any two or more of (a)—(f).

31. The method of claim 21 wherein providing the information to the one or more wireless devices comprises broadcasting the information.

32. The method of claim 21 wherein providing the information to the one or more wireless devices comprises providing the information to each of the one or more wireless device via dedicated signaling.

33. (canceled)

34. (canceled)

35. A network node for a cellular communications system, the network node comprising processing circuitry configured to cause the network node to:
provide, to one or more wireless devices, information that defines, for each transition between two operational states in a set of two or more operational states:
one or more measurement requirements that are applicable during a transition period; and
the transition period.

36-38. (canceled)

39. A non-transitory computer readable medium comprising instructions executable by processing circuitry of a network node to thereby cause the network node to:
provide, to one or more wireless devices, information that defines, for each transition between two operational states in a set of two or more operational states:
one or more measurement requirements that are applicable during a transition period; and
the transition period.
